(19) United States
(12) Patent Application Publication
(10) Pub. No.: US 2009/0035973 A1
(43) Pub. Date: Feb. 5, 2009

(54) Connector having connection detecting means which is elastically deformable

(75) Inventors: Takeharu Naito, Tokyo (JP); Takaaki Kudo, Tokyo (JP)

Correspondence Address: COLLARD & ROE, P.C., 1077 NORTHERN BOULEVARD, ROSLYN, NY, 11576, US

(73) Assignee: Japan Aviation Electronics Industry, Limited

(21) Appl. No.: 12/220,997

(22) Filed: Jul. 30, 2008

(30) Foreign Application Priority Data
Jul. 31, 2007 (JP) 2007-199967

(51) Int. Cl. H01R 29/00

(52) U.S. Cl. 439/188

(57) ABSTRACT

In a connector to be connected to a connection object, a housing holds at least one contact to be contacted with the connection object and a switch for detecting whether the connection object is in a connected state or an unconnected state. The switch includes a first conductive member and a second conductive member. The first conductive member includes a first spring portion which is elastically deformable and extends in a first direction to have a free end, a conductive member abutting portion which is formed at the free end of the first spring portion and adapted to the abutted to the connection object in the connected state in a second direction perpendicular to the first direction, and a first contact point which is connected to the first spring portion. The second conductive member includes a second contact point faced to the first contact point in the second direction.

This application is based upon and claims the benefit of priority from Japanese patent application No. 2007-199967, filed on Jul. 31, 2007, the disclosure of which is incorporated herein in its entirety by reference.

### TECHNICAL FIELD

This invention relates to a connector capable of electrically detecting a connected state of a connection object.

### BACKGROUND ART

Proposal has been made of a connector comprising a contact for obtaining electrical connection with a connection object and connection detecting means for detecting a connected state of the connection object. The connection detecting means generally uses a conductive component having a shape same as or similar to that of the contact. When the connection object is normally connected to the connector, the connection object operates the conductive component so that the connected state of the connection object is electrically detected. Accordingly, in case where the connection object is made of a relatively hard material, for example, in case where the connection object is a typical printed board or a typical IC package, it is relatively easy to detect the connected state of the connection object by the use of the connection detecting means of the type described.

### SUMMARY OF THE INVENTION

However, in case where the connection object is made of a relatively soft material, for example, in case where the connection object is a flexible cable or a flexible board, it is difficult to detect the connected state of the connection object by the use of the connection detecting means using the conductive component having a shape same as or similar to that of the contact. This is because the connection object made of a relatively soft material is not suitable to operate the conductive component having a shape same as or similar to that of the contact. It is noted here that the connection object and the contact can be brought into contact with each other by operating a special operating member.

Under the above-mentioned circumstances, it is proposed to detect the connected state of the connection object, for example, by a visual sense of an operator in case where the connection object is made of a relatively soft material (see JP-U-H05-94968). In this approach, however, there is a problem with detection accuracy because the visual sense of the operator is relied upon.

It is also proposed to perform detection by a tactile sense (JP-A-2006-100165). However, in this technique also, there is a problem with detection accuracy because the tactile sense of the operator is relied upon.

It is therefore an exemplary object of this invention to provide a connector capable of reliably and easily carrying out electrically detection of a connected state of a connection object.

Other objects of the present invention will become clear as the description proceeds.

According to an exemplary aspect of the present invention, there is provided a connector to be connected to a connection object, the connector comprising at least one contact to be contacted with the connection object, a switch for detecting whether the connection object is in a connected state or an unconnected state, and a housing which holds the at least one contact and the switch, wherein the switch includes a first conductive member and a second conductive member, the first conductive member includes a first spring portion which is elastically deformable and extends in a first direction to have a free end, a conductive member abutting portion which is formed at the free end of the first spring portion and adapted to the abutted to the connection object in the connected state in a second direction perpendicular to the first direction, and a first contact point which is connected to the first spring portion, and the second conductive member includes a second contact point faced to the first contact point in the second direction.

### BRIEF DESCRIPTION OF THE DRAWING

FIG. 1 is a perspective view of a connector according to an exemplary embodiment of this invention when an actuator is closed;

FIG. 2 is a perspective view of the connector in FIG. 1 when the actuator is opened;

FIG. 3 is an enlarged perspective view of a switch of the connector illustrated in FIGS. 1 and 2;

FIG. 4 is an enlarged side view of the switch illustrated in FIG. 3;

FIG. 5 is a plan view of the connector in FIG. 1 when the actuator is opened;

FIG. 6 is an enlarged sectional view taken along a line VI-VI in FIG. 5;

FIG. 7 is a partially-removed enlarged plan view showing the connector in FIG. 1 together with a connection object; and

FIG. 8 is an enlarged sectional view similar to FIG. 6 and in the state illustrated in FIG. 7.

### DESCRIPTION OF THE EXEMPLARY EMBODIMENT

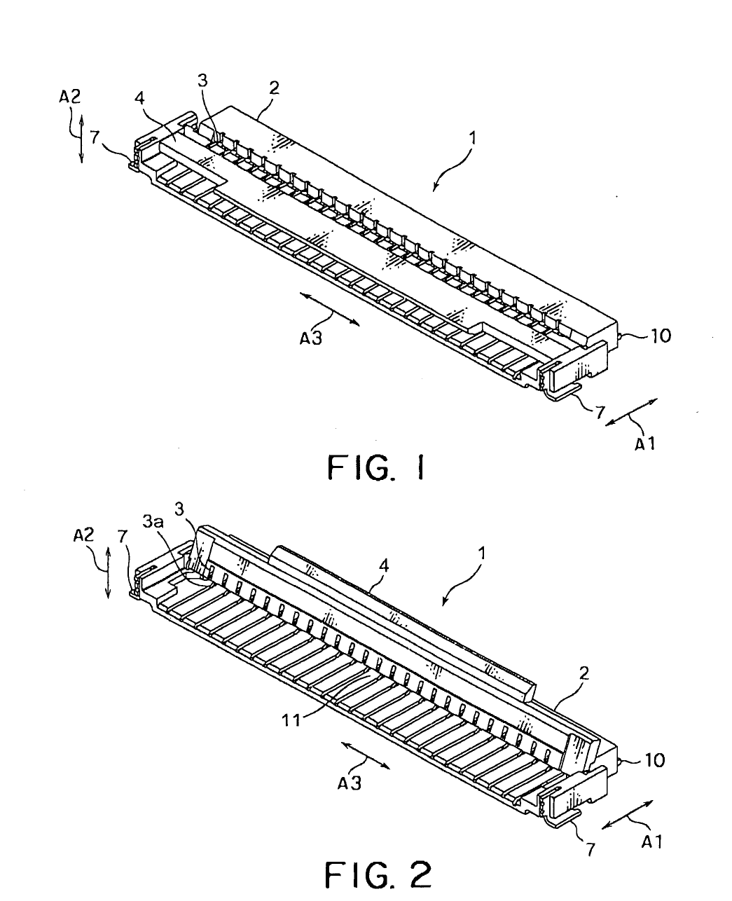

Referring to FIGS. 1 and 2, description will be made of a connector according to an exemplary embodiment of this invention.

The connector illustrated in FIG. 1 is depicted by a reference numeral 1 and comprises an elongated housing 2 made of an insulating material. Herein, a width direction A1, a thickness direction A2, and a longitudinal direction A3 of the housing 2 will be called a first direction, a second direction, and a third direction, respectively.

The housing 2 holds a number of conductive contacts 3 arranged in a single row and in parallel to one another in the third direction A3 at a predetermined pitch. The housing 2 is provided with an actuator 4 made of an insulating material. The actuator 4 is mounted to the housing 2 so as to be rotatable with respect to an axis extending in the third direction A3. Furthermore, the housing 2 is provided with a pair of stiffeners 7 which are mounted to opposite sides thereof in the third direction A3, respectively, and which are adapted to be soldered to a mounting board (not shown) as a mounting object.

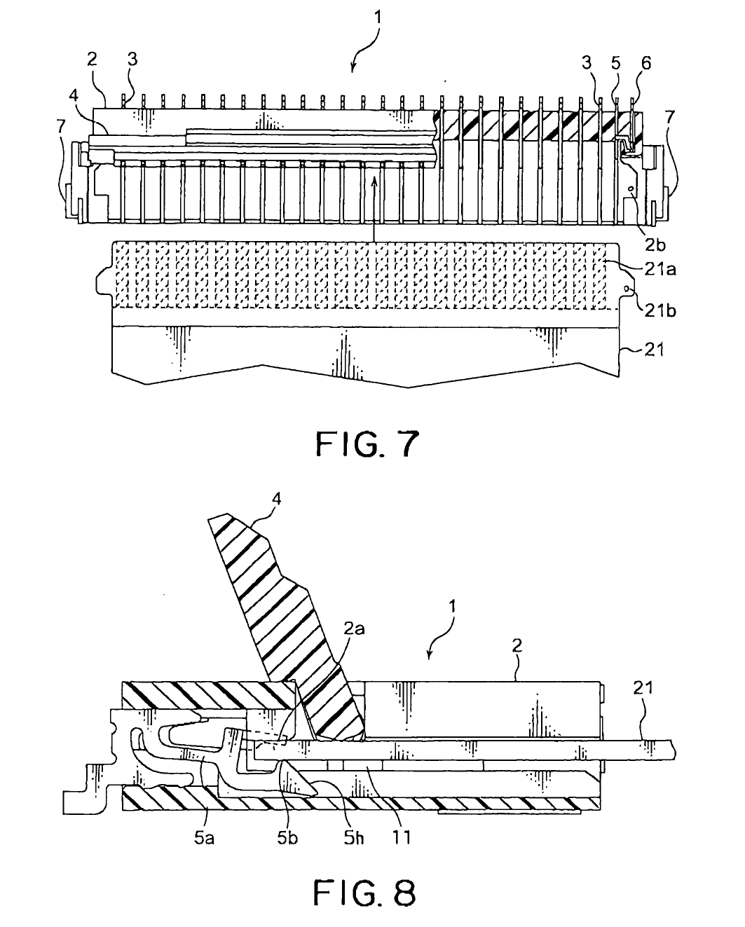

The connector 1 has an opening 11 defined by the housing 2. When the actuator 4 is opened as illustrated in FIG. 2, a flexible board as a connection object depicted by a reference numeral 21 in FIGS. 7 and 8 can be inserted into the opening 11 of the connector 1. In the opening 11, a plurality of contacting portions 3a of the contacts 3 are arranged in parallel to one another. When the actuator 4 is closed as shown in FIG. 1 after the flexible board is inserted into the opening 11, the actuator 4 brings the flexible board into press contact with the contacting portions 3a of the contacts 3. Thus, the flexible board 21 is connected to the connector 1.

The connector 1 further comprises a switch 10 as connection detecting means for detecting whether the flexible board 21 is in a connected state or an unconnected state. The switch 10 is held at one end of the housing 2 in the third direction A3 to be adjacent to the opening 11 as will later be described. The switch 10 is used to electrically detect an insertion state of the flexible board when it is inserted into the connector 1, i.e., to electrically detect whether or not the flexible board is properly inserted into the connector 1.

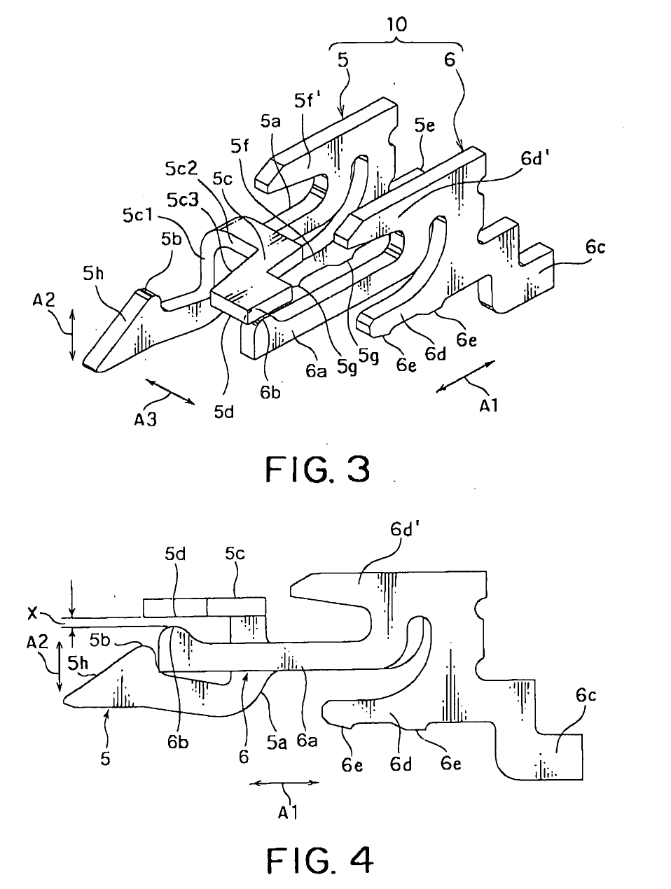

Referring to FIGS. 3 and 4 in addition, the switch 10 will be described.

The switch 10 comprises a first conductive piece or member 5 and a second conductive piece or member 6 adjacent to and in parallel to each other in the third direction A3. Each of the first and the second conductive members 5 and 6 is made of a metal material.

The first conductive member 5 includes a first spring portion 5a having a free end at one end and elastically deformable an abutting portion 5b formed adjacent to the free end of the first spring portion 5a, a connecting portion 5c extending from the first spring portion 5a, and a first contact point 5d formed on the connecting portion 5c. The abutting portion 5b is formed as a protrusion protruding from the first spring portion 5a in the second direction A2.

In order to obtain an excellent spring characteristic, the connecting portion 5c has a shape as a combination of two generally L-shaped portions. More in detail, the connecting portion 5c includes a first part 5c1 which extends from an intermediate position of the first spring portion 5a that is away from the free end of the first spring portion 5a and which extends in the second direction A2, a second part 5c2 bent from the first part 5c1 in the third direction A3 towards the second conductive member 6, and a third part 5c3 further bent from the second part 5c2 in the first direction A1 and connected to the first contact point 5d. The first contact point 5d has a plate-like shape widened in the first and the third directions A1 and A3.

The first conductive member 5 further has a first terminal portion 5e to be soldered to the mounting board and a pair of press-fit portions 5f and 5f′ to be press-fitted to the housing 2. The first terminal portion 5e and the press-fit portions 5f and 5f′ are integrally formed with the other end of the first spring portion 5a. Even in a state where the press-fit portions 5f and 5f′ are press-fitted into the housing 2, the first spring portion 5a is elastically deformable. Therefore, the abutting portion 5b is movable at least in the second direction A2.

The second conductive member 6 includes a second spring portion 6a having a free end at one end and elastically deformable, a second contact point 6b formed adjacent to the free end of the second spring portion 6a, a second terminal portion 6c to be soldered to the mounting board, and a pair of press-fit portions 6d and 6d′ to be press-fitted into the housing 2. The second terminal portion 6c and the press-fit portions 6d and 6d′ are integrally formed with the other end of the second spring portion 6a. The second contact point 6b is formed as a protrusion protruding from the second spring portion 6a in the second direction A2. In detail, the second contact point 6b of the second conductive member 6 protrudes in a direction same as that of the abutting portion 5b of the first conductive member 5 and is faced to the first contact point 5d of the first conductive member 5 with a gap X left therebetween.

The press-fit portions 5f and 5f′ are generally identical in shape with the press-fit portions 6d and 6d′. The press-fit portions 5f and 6d are provided with press-fit projections 5g and 6e which are engaged with a holding portion of the housing 2 so that the both of the first and the second conductive members 5 and 6 are securely held by the housing 2. The first spring portion 5a is provided with a slant surface 5h formed between the abutting portion 5b and the free end and adapted to be contacted with the flexible board 21 inserted through the opening 11. The first and the second terminal portions 5e and 6c are soldered and connected to an electric circuit of the mounting board.

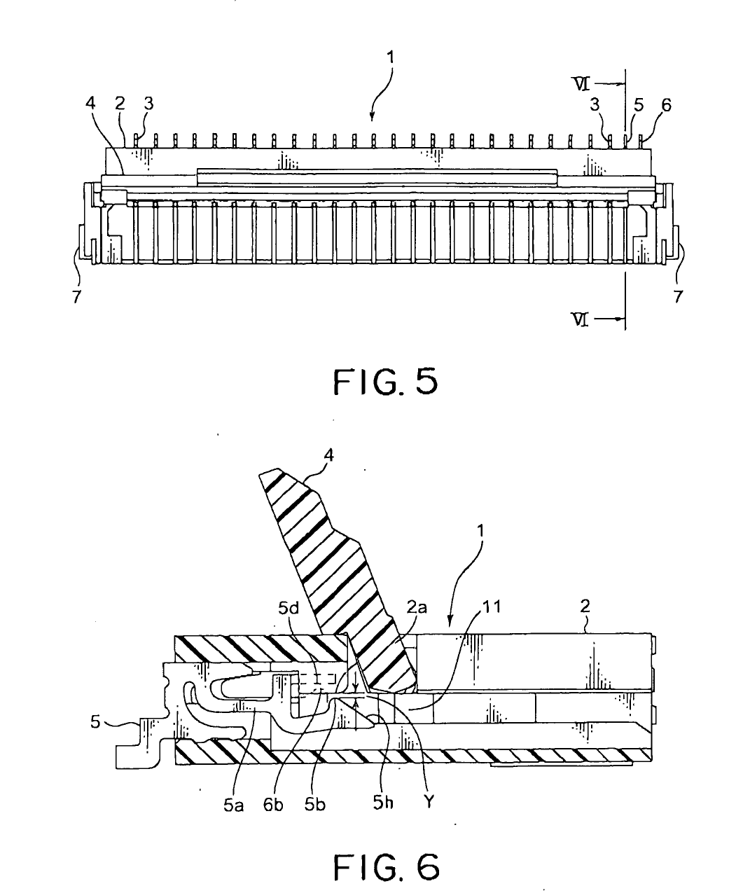

Referring to FIGS. 5 to 7 in addition, description will proceed further.

In FIGS. 5 and 6, the flexible board 21 is not yet inserted into the opening 11 of the housing 2. A gap Y between a housing abutting portion 2a of the housing 2 and the abutting portion 5b of the first conductive member 5 is slightly smaller than the thickness of the flexible board 21. In this state, the first contact point 5d of the first conductive member 5 is separated from the second contact point 6b of the second conductive member 6. Therefore, the first and the second conductive members 5 and 6 are electrically disconnected from each other.

Referring to FIG. 7, the connector 1 is illustrated with a part cutaway so that the interior is seen. The flexible board 21 as the connection object has a rear surface on which a number of conductors 21a are arranged in a single row at a predetermined pitch. The contacts 3 of the connector 1 are disposed at positions corresponding to the conductors 21a, respectively. The first conductive member 5 of the connector 1 is disposed at a position deviated from the conductors 21a of the flexible board 21.

When the flexible board 21 is inserted into the connector 1, the flexible board 21 passes through the opening 11 of the housing 2 to be abutted to the slant surface 5h of the first spring portion 5a. When the flexible board 21 is further inserted inward as illustrated in FIG. 8, the flexible board 21 presses the slant surface 5h to elastically deform the first spring portion 5a and advances into an area between the housing abutting portion 2a of the housing 2 and the abutting portion 5b of the second conductive member 5 to widen the gap Y to the thickness of the flexible board 21. Due to the elastic deformation of the first spring portion 5a at this time, the first contact point 5d is moved over a distance greater than the gap X. As a consequence, the first contact point 5d of the first conductive member 5 moves downward to be brought into press contact with the second contact point 6b of the second conductive member 6. Accordingly, the first and the second conductive members 5 and 6 are electrically connected to each other.

The fact that the first and the second conductive members 5 and 6 are electrically connected to each other may be informed to an operator by light emission of a lamp or a ringing sound of a buzzer which is disposed at an appropriate position of the mounting board or the connector 1.

In order to prevent the flexible board 21 from being undesirably removed from the connector 1, the housing 2 is provided with a stopper recess 2b while the flexible board 21 is provided with a stopper protrusion 21b. When the flexible board 21 is completely inserted into the housing 2 of the connector 1 and the actuator 4 is rotated to connect the flexible board 21 to the connector 1, the stopper recess 2b and the stopper protrusion 21b are engaged with each other to prevent the flexible board 21 from being removed.

With the above-mentioned connector 1, various exemplary advantages will be expected as enumerated below.

1. When the connection object is properly inserted into the connector 1, the first and the second conductive members 5 and 6 are electrically connected to each other. It is therefore possible to reliably detect whether or not the flexible board 21 is properly inserted.

2. The first and the second conductive members 5 and 6 are connected with elastic deformation of the spring portions 5a and 6a. Therefore, even if the connection object is made of a relatively soft material, for example, even if the connection object is flexible, a stable and reliable operation is achieved.

3. The housing 2 only requires a working step of forming the housing abutting portion 2a to be abutted to the connection object when it is inserted. Therefore, required modification is very little.

4. The first spring portion 5a has a plurality of L-shaped portions. Therefore, an excellent spring characteristic is obtained and the connector 1 has a space-saving structure.

5. The switch 10 comprises the first and the second conductive members 5 and 6. Thus, the connector 1 can be made to have a simple structure.

Next, various exemplary embodiments of this invention will be enumerated in the following items 1-12.

1. A connector to be connected to a connection object 21, the connector comprising:

at least one contact 3 to be contacted with the connection object 21;

a switch 10 for detecting whether the connection object 21 is in a connected state or an unconnected state; and

a housing 2 which holds the at least one contact 3 and the switch 10;

wherein the switch 10 includes a first conductive member 5 and a second conductive member 6;

the first conductive member 5 includes:

a first spring portion 5a which is elastically deformable and extends in a first direction A1 to have a free end;

a conductive member abutting portion 5b which is formed at the free end of the first spring portion and adapted to the abutted to the connection object 21 in the connected state in a second direction A2 perpendicular to the first direction A1; and

a first contact point 5d which is connected to the first spring portion 5a; and

the second conductive member 6 includes a second contact point 6b faced to the first contact point 5d in the second direction A2.

2. The connector according to item 1, wherein the first and the second conductive members 5 and 6 are disposed adjacent to each other in a third direction A3 perpendicular to the first and the second directions A1 and A2.

3. The connector according to item 1, wherein the second conductive member 6 further comprise a second spring portion 6a which is elastically deformable and extends in the first direction A1 to have a free end, and the second contact point 6b is formed at the free end of the second spring portion 6a.

4. The connector according to item 3, wherein the first and the second contact points 5d and 6b are deviated in position from each other in the first direction A1.

5. The connector according to item 1, wherein the housing 2 comprises a housing abutting portion 2a which is faced to the conductor abutting portion 5b in the second direction A2, and the connection object 21 is inserted into an area between the housing abutting portion 2a and the conductor abutting portion 5b in the connected state.

6. The connector according to item 5, wherein the relationship between the conductor abutting portion 5b and the housing abutting portion 2a is determined so that, in the connected state, the first spring portion 5a is pressed by the connection object 21 to be elastically deformed.

7. The connector according to item 5, wherein the housing 2 has an opening 11 for receiving the connection object 21 to be inserted therein in the first direction A1.

8. The connector according to item 1, wherein the housing 2 has an opening 11 for receiving the connection object 21 to be inserted therein in the first direction A1, and the switch 10 is disposed at a position corresponding to one end of the opening 11 in a third direction A3 perpendicular to the first and the second directions A1 and A2.

9. The connector according to item 8, wherein the at least one contact 3 is disposed at a position corresponding to an intermediate position of the opening 11 in the third direction A3.

10. The connector according to item 1, wherein the first conductive member 5 further comprises a connecting portion 5c connecting the first contact point 5d to the first spring portion 5a, and the connecting portion 5c comprises at least one substantially L-shaped portion.

11. The connector according to item 1, wherein the first spring portion 5 comprises an intermediate portion which is away from the free end thereof, the first conductive member 5 further includes a connecting portion 5c connecting the first contact point 5d to the first spring portion 5a, the connecting portion 5c comprises:

a first part 5c1 which extends from the intermediate portion in the second direction A2; and

a second part 5c2 which is bent from the first part in a third direction A3 perpendicular to the first and the second directions A2 and A3.

12. The connector according to item 11, wherein the connecting portion 5c includes a third part bent 5c3 from the second part 5c2 in the first direction A1 and connected to the first contact point 5d.

While the present invention has thus far been described in connection with the exemplary embodiment thereof, it will readily be possible for those skilled in the art to put this invention into practice in various other manners. In the above-mentioned connector, the switch is mounted to only one side of the housing in the third direction. Alternatively, a pair of the switches may be mounted to the opposite sides of the housing, respectively. The first spring portion may have only one L-shaped portion. Instead of the flexible board, the flexible cable can be connected to the connector.

What is claimed is:

1. A connector to be connected to a connection object, the connector comprising:
at least one contact to be contacted with the connection object;
a switch for detecting whether the connection object is in a connected state or an unconnected state; and
a housing which holds the at least one contact and the switch;
wherein the switch includes a first conductive member and a second conductive member;
the first conductive member includes:
a first spring portion which is elastically deformable and extends in a first direction to have a free end;
a conductive member abutting portion which is formed at the free end of the first spring portion and adapted to the abutted to the connection object in the connected state in a second direction perpendicular to the first direction; and
a first contact point which is connected to the first spring portion; and
the second conductive member includes a second contact point faced to the first contact point in the second direction.

2. The connector according to claim 1, wherein the first and the second conductive members are disposed adjacent to each other in a third direction perpendicular to the first and the second directions.

3. The connector according to claim 1, wherein the second conductive member further comprise a second spring portion which is elastically deformable and extends in the first direction to have a free end, and the second contact point is formed at the free end of the second spring portion.

4. The connector according to claim 3, wherein the first and the second contact points are deviated in position from each other in the first direction.

5. The connector according to claim 1, wherein the housing comprises a housing abutting portion which is faced to the conductor abutting portion in the second direction, and the connection object is inserted into an area between the housing abutting portion and the conductor abutting portion in the connected state.

6. The connector according to claim 5, wherein the relationship between the conductor abutting portion and the housing abutting portion is determined so that, in the connected state, the first spring portion is pressed by the connection object to be elastically deformed.

7. The connector according to claim 5, wherein the housing has an opening for receiving the connection object to be inserted therein in the first direction.

8. The connector according to claim 1, wherein the housing has an opening for receiving the connection object to be inserted therein in the first direction, and the switch is disposed at a position corresponding to one end of the opening in a third direction perpendicular to the first and the second directions.

9. The connector according to claim 8, wherein the at least one contact is disposed at a position corresponding to an intermediate position of the opening in the third direction.

10. The connector according to claim 1, wherein the first conductive member further comprises a connecting portion connecting the first contact point to the first spring portion, and the connecting portion comprises at least one substantially L-shaped portion.

11. The connector according to claim 1, wherein the first spring portion comprises an intermediate portion which is away from the free end thereof, the first conductive member further includes a connecting portion connecting the first contact point to the first spring portion, the connecting portion comprises:
a first part which extends from the intermediate portion in the second direction; and
a second part which is bent from the first part in a third direction perpendicular to the first and the second directions.

12. The connector according to claim 11, wherein the connecting portion includes a third part bent from the second part in the first direction and connected to the first contact point.
